(19) United States
(12) Patent Application Publication
(10) Pub. No.: US 2006/0250644 A1
(43) Pub. Date: Nov. 9, 2006

(54) Image forming system, image forming apparatus, storage device, and communication control method and program

(75) Inventors: Manabu Yamauchi, Kashiwa-shi (JP); Ryuta Mine, Toride-shi (JP); Naoto Yamada, Kawasaki-shi (JP); Hideyuki Ikegami, Abiko-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/406,415

(22) Filed: Apr. 19, 2006

(30) Foreign Application Priority Data
May 9, 2005 (JP) 2005-136504

(51) Int. Cl. G06F 3/12

(52) U.S. Cl. 358/1.15

(57) ABSTRACT

This specification discloses a system, apparatus, and method for preventing leakage of various kinds of information (e.g., various kinds of setting information, software, user data, and job information) from a storage device which supplies information to an image forming apparatus. More specifically, in an image forming system including an image forming apparatus which is connected to a storage device and forms an image by using information read out from the storage device, and an information processing apparatus which manages the image forming apparatus, the information processing apparatus determines whether to permit communication between the storage device and the image forming apparatus.

### FIELD OF THE INVENTION

The present invention relates to an image forming system, image forming apparatus, storage device, and communication control method and program.

### BACKGROUND OF THE INVENTION

Recently, there has been proposed an image forming apparatus which is connected to a storage device such as an HDD (Hard Disk Drive) and forms an image by using information read out from the storage device. This image forming apparatus uses the storage device as an area where, for example, externally accepted job data is temporarily saved and read out, as needed. In some cases, the storage area of the storage device is used to increase the processing efficiency and to change the job priority. A special storage area where only a specific user or group can read/write is sometimes ensured in the storage device, and provided with security to save a secret document (job data). In addition, the storage device may hold various kinds of setting information (configuration information, FAX address book, and settings for each user), and application software which runs by using functions of a multi-functional peripheral.

For such an image forming apparatus, there are made “proposal of designing a detachable HDD as a storage device and when the HDD is not in use, detaching it from an image forming apparatus in order to further reinforce security” (see, e.g., Japanese Patent Laid-Open No. 03-105365), and “proposal of completely erasing highly secret data from the HDD and RAM in an image forming apparatus” (see, e.g., Japanese Patent Laid-Open No. 09-223061).

However, in the conventional image forming apparatus, work to ensure security of various kinds of setting information and many job data is very cumbersome. For example, it requires much labor to remove from the image forming apparatus an HDD which stores information on the image forming apparatus, and to keep the HDD in the safe. If highly secret data is completely erased from the apparatus in order to maintain confidentiality, the user cannot leave desired data stored, resulting in poor user friendliness.

### SUMMARY OF THE INVENTION

The present invention has been made to overcome the conventional drawbacks, and has as its object to provide a technique capable of easily preventing leakage of data in a storage device.

According to one aspect of the present invention, an image forming system comprising an image forming apparatus which is connected to a storage device and forms an image by using information read out from the storage device, and an information processing apparatus which manages the image forming apparatus is characterized in that

the information processing apparatus determines whether to permit communication between the storage device and the image forming apparatus.

According to another aspect of the present invention, an image forming apparatus which is connected to a storage device and forms an image by using information read out from the storage device is characterized in that

the image forming apparatus inquires, of an information processing apparatus which manages the image forming apparatus, whether to permit communication between the image forming apparatus and the storage device.

According to still another aspect of the present invention, a storage device which stores information to be supplied to an image forming apparatus for forming an image is characterized in that

the storage device establishes communication with the image forming apparatus after waiting for permission from an information processing apparatus which manages the image forming apparatus.

According to one aspect of a method of the present invention, a communication control method of causing an information processing apparatus to control communication between a storage device and an image forming apparatus which forms an image while saving information in the storage device is characterized by comprising

causing the information processing apparatus to determine whether to permit communication between the storage device and the image forming apparatus.

The communication control method preferably further comprises steps of

causing the image forming apparatus to request the information processing apparatus to establish communication with the storage device, and

causing the information processing apparatus to determine whether the requesting image forming apparatus and the storage device are management targets.

According to one aspect of a program of the present invention, a communication control program of controlling communication between a storage device and an image forming apparatus which forms an image while saving information in the storage device is characterized by comprising

determining whether to permit communication between the storage device and the image forming apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic view for explaining the structure of an image forming apparatus according to an embodiment of the present invention;

FIG. 2 is a block diagram for explaining the control configuration of the image forming apparatus according to the embodiment of the present invention;

FIG. 3 is a block diagram for explaining the configuration of a control section shown in FIG. 2;

FIGS. 4A to 4C are schematic views for explaining an example of a recording area shown in FIG. 3;

FIG. 5 is a flowchart showing an example of secure access request processing according to the embodiment of the present invention;

FIG. 6 is a flowchart showing an example of proxy SA processing according to the embodiment of the present invention;

FIG. 7 is a flowchart showing an example of secure communication response processing according to the embodiment of the present invention;

FIGS. 8A to 8C are views each showing an example of a security policy database (SPD) according to the embodiment of the present invention; and

FIGS. 9A and 9B are views each showing an example of a security association database (SAD) according to the embodiment of the present invention.

### DETAILED DESCRIPTION OF THE PREFERRED EMBODIMENTS

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

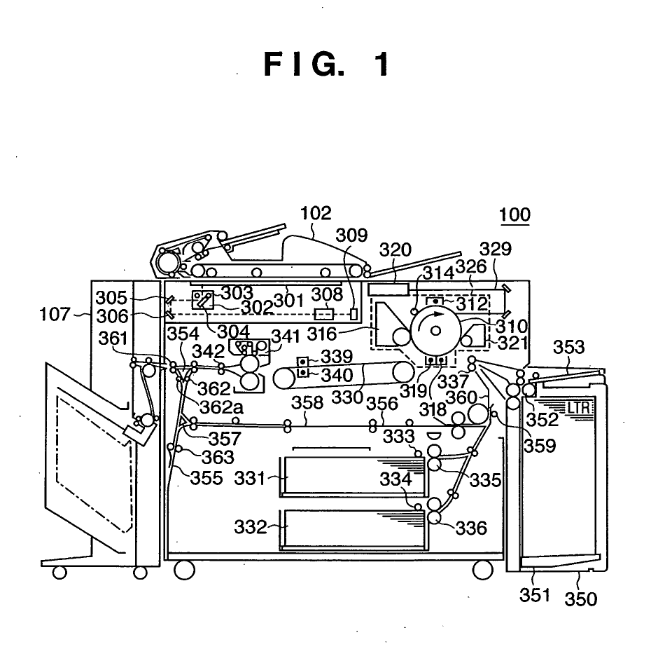

FIG. 1 is a sectional view for explaining the structure of an image forming apparatus according to the embodiment. In the embodiment, a multi-functional image forming apparatus will be explained as an example of the image forming apparatus.

In FIG. 1, reference numeral 100 denotes an image forming apparatus; 102, a document feeding unit (to be referred to as a DF unit hereinafter); and 301, a platen glass serving as a document table. Reference numeral 302 denotes a scanner which is made up of a document illumination lamp 303, scanning mirror 304, and the like. The scanner 302 is reciprocally scanned in a predetermined direction by a motor (not shown), and forms light reflected by a document into an image on a CCD sensor (image sensor unit) 309 through a lens 308 via scanning mirrors 304 to 306.

Reference numeral 320 denotes an exposure control unit which is made up of a laser, polygon scanning mirror, and the like, and irradiates a photosensitive drum 310 with a laser beam 329 modulated on the basis of an image signal that is converted into an electrical signal by the image sensor unit 309 and undergoes image processing. A primary charger 312, developing unit 321, transfer charger 318, separation charger 319, cleaning device 316, and pre-exposure lamp 314 are arranged around the photosensitive drum 310.

In an image forming section 326, the photosensitive drum 310 rotates in a direction indicated by an arrow in FIG. 1 by a motor (not shown). The photosensitive drum 310 is charged to a desired potential by the primary charger 312, and irradiated with the laser beam 329 traveling from the exposure control unit 320, forming an electrostatic latent image. The electrostatic latent image formed on the photosensitive drum 310 is developed by the developing unit 321, and visualized as a toner image.

A printing paper sheet fed by a pickup roller 333 or 334 from an upper printing paper cassette 331 or lower printing paper cassette 332 is sent to the main body by paper feed rollers 335 or 336, and fed to a transfer belt by registration rollers 337. The visualized toner image is transferred onto the printing paper sheet by the transfer charger 318 and separation charger 319. Residual toner is cleaned by the cleaning device 316 from the photosensitive drum 310 after transfer, and residual charges are removed by the pre-exposure lamp 314. The printing paper sheet after transfer is separated from a transfer belt 330. The toner image is charged again by pre-fixing chargers 339 and 340, and the printing paper sheet is sent to a fixing unit 341 where the toner image is pressed, heated, and thereby fixed. The printing paper sheet is then discharged by discharge rollers 342 onto a finisher unit 107.

The image forming apparatus 100 is equipped with a deck 350 capable of storing, e.g., 4,000 printing paper sheets. A lifter 351 of the deck 350 moves up in accordance with the amount of printing paper sheets so that a printing paper sheet always abuts against a paper feed roller 352.

The image forming apparatus 100 is also equipped with a multiple manual feeder 353 capable of storing 100 printing paper sheets. In FIG. 1, reference numeral 354 denotes a delivery flapper which switches the delivery path between double-sided printing and multiple printing. A printing paper sheet sent from the discharge rollers 342 is switched to double-sided or multiple printing by the delivery flapper 354. Reference numeral 358 denotes a lower convey path which reverses a printing paper sheet sent from the discharge rollers 342 via a reverse path 355, and guides the printing paper sheet to a refeed tray 356. Reference numeral 357 denotes a multiple flapper which switches the path between double-sided printing and multiple printing. By shifting the multiple flapper 357 to the left, a printing paper sheet is directly guided to the lower convey path 358 without the mediacy of the reverse path 355.

Reference numeral 359 denotes a paper feed roller which feeds a printing paper sheet to the photosensitive drum 310 via a path 360. Reference numeral 361 denotes discharge rollers which are arranged near the delivery flapper 354, and discharge, outside the apparatus, a printing paper sheet switched to the discharge side by the delivery flapper 354. In double-sided printing (double-sided copying) or multiple printing (multiple copying), the delivery flapper 354 is moved up, and a copied printing paper sheet is stored in the refeed tray 356 while reversed to face down via the reverse path 355 and lower convey path 358.

In double-sided printing, the multiple flapper 357 is shifted to the right. In multiple printing, printing paper sheets stored in the refeed tray 356 are guided one by one from the bottom by the paper feed roller 359 to the registration rollers 337 of the image forming apparatus 100 via the path 360. When a printing paper sheet is determined and discharged from the image forming apparatus 100, the delivery flapper 354 is moved up, the multiple flapper 357 is shifted to the right, and a copied printing paper sheet is transferred to the reverse path 355. After the trailing end of the printing paper sheet passes through a first feed roller 362, it is conveyed to a second feed roller 362a via reverse rollers 363, reversed by the discharge rollers 361 to face down, and discharged to the finisher unit 107.

Note that FIG. 1 shows an example of the image forming apparatus 100 capable of single-color printing. However, the present invention can also be applied to an image forming apparatus capable of printing in a plurality of colors, e.g., two (red and black colors), three (yellow, cyan, and magenta colors), or four (yellow, cyan, magenta, and black colors).

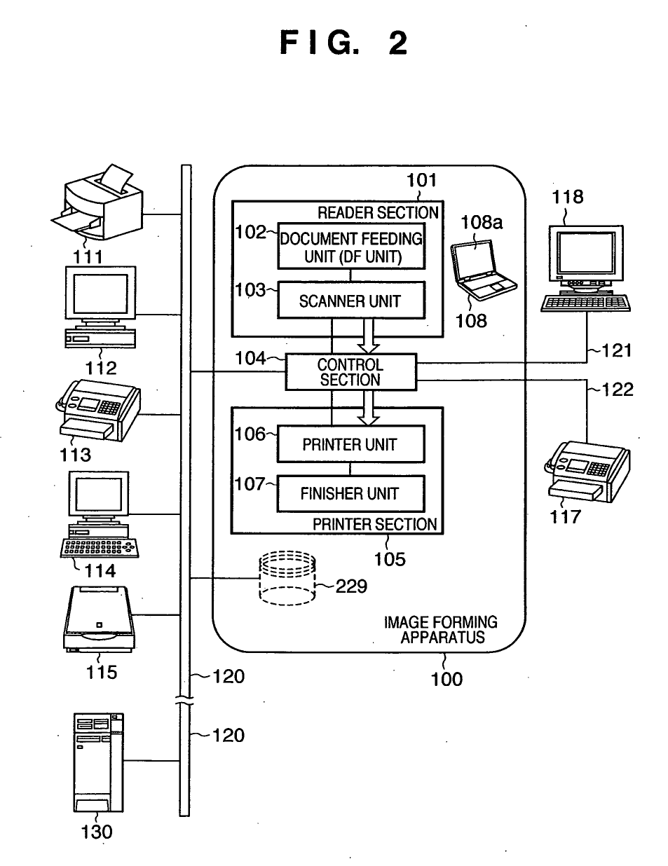

FIG. 2 is a block diagram for explaining the control configuration of the image forming apparatus according to the embodiment.

In FIG. 2, reference numeral 101 denotes a reader section serving as an image input device which optically reads a document and converts it into image data. The reader unit 101 comprises a scanner unit 103 having a function of actually optically reading a document, and the DF unit 102 having a function of automatically conveying a document so that the scanner unit 103 can read it.

Reference numeral 105 denotes a printer section serving as an image output device which has a plurality of types of printing paper cassettes (upper and lower printing paper cassettes 331 and 332). In accordance with a printing instruction, the printer section 105 converts image data into a visual image on a printing paper sheet conveyed from the printing paper cassette. The printer section 105 comprises a printer unit 106 having a function of transferring and fixing image data onto a printing paper sheet, and the finisher unit 107 which, for example, sorts and staples printing paper sheets each bearing a fixed image.

Reference numeral 104 denotes a control section which is electrically connected to the reader section 101 and printer section 105, comprehensively controls the image forming apparatus 100, various devices connected to the image forming apparatus 100, and the like, and has various functions. As circuits for executing various functions, the control section 104 comprises a FAX communication unit, computer I/F (interface) communication units, an image processing unit, a PDL formatter unit, and an operation section I/F.

Reference numeral 108 denotes an operation section of the image forming apparatus 100. The operation section 108 is a user I/F section which has a large-size liquid crystal touch panel 108a and allows the user to easily issue an execution instruction and the like to the image forming apparatus 100.

The image forming apparatus 100 which is formed from the above-described reader section 101, control section 104, printer section 105, and operation section 108 can communicate with various external apparatuses via the control section 104.

Reference numerals 112 and 118 denote personal computers (PCs) which are generally used by the user and create a document and the like. The PC 112 is connected to the control section 104 via a network (LAN (Local Area Network), WAN (Wide Area Network), or the like) 120. The PC 118 is connected to the control section 104 via a computer I/F 121.

The PC 112 can exchange e-mail with another computer connected to the network 120, and browse an HTML file by services of a server such as an HTTP server on the network 120.

Reference numeral 114 denotes a computer functioning as a workstation (WS); and 113 and 117, facsimile apparatuses (FAXs). The FAX 113 can communicate with the image forming apparatus 100 via the network 120, whereas the FAX 117 can communicate with the image forming apparatus 100 via a public line 122 (G3 or G4 which is an international communication standard of the FAX). Reference numeral 111 denotes a printer; and 115, a scanner.

Reference numeral 229 denotes an HDD which can record and reproduce various kinds of information and jobs processed by the image forming apparatus 100.

Reference numeral 130 denotes a server which is connected to the control section 104 and HDD 229 via the network 120.

The network 120 is generally Ethernet or the like. The computer I/F 121 is generally RS232C, Centronics I/F, IEEE1284, SCSI, or the like.

The above-described image forming apparatus 100 is an example of an image forming apparatus having the control section 104 capable of connecting an accessory apparatus having a plurality of functions. The image forming apparatus 100 can be connected to the PCs 112 and 118 via connection media such as the network 120, and can print out and facsimile-transmit data on the PCs 112 and 118.

The image forming apparatus 100 and HDD 229 are shipped after storing manufacturing IDs and the like as device IDs in their ROMs, and individually storing secret symmetric keys which are shared only between the image forming apparatus 100 and the server 130 and between the HDD 229 and the server 130.

The server 130 makes the device IDs and secret symmetric keys of the image forming apparatus 100 and HDD 229, which are shipped from the factory, correspond to each other, and holds the device IDs and secret symmetric keys for the respective shipped devices. The secret symmetric keys are stored in the image forming apparatus 100′, HDD 229, and server 130 upon data-split, encryption, tamper-resistant processing, and the like so that the keys cannot be read out by a general method.

With this setting, the server 130 can achieve proxy establishment of a security association (SA) in communication between the control section 104 of the image forming apparatus 100 and the HDD 229. Establishment of the security association means exchanging and sharing information such as the encryption method and encryption key before the start of communication, and establishing a secure communication channel in encrypted communication using IPsec or IPv6. That is, the SA means an established virtual encrypted communication channel (tunnel). In SA establishment in IPsec, determination of the encryption method, exchange of keys, and mutual authentication are done by a standard procedure IKE (Internet Key Exchange). The SA is periodically updated to identify the user and issue/exchange an encryption key again. Each of the image forming apparatus 100, HDD 229, and server 130 holds a globally Unique IP address, and the address may be an IPv4 or IPv6 address. Similarly, the network 120 may be either of IPv4 and IPv6 protocol networks.

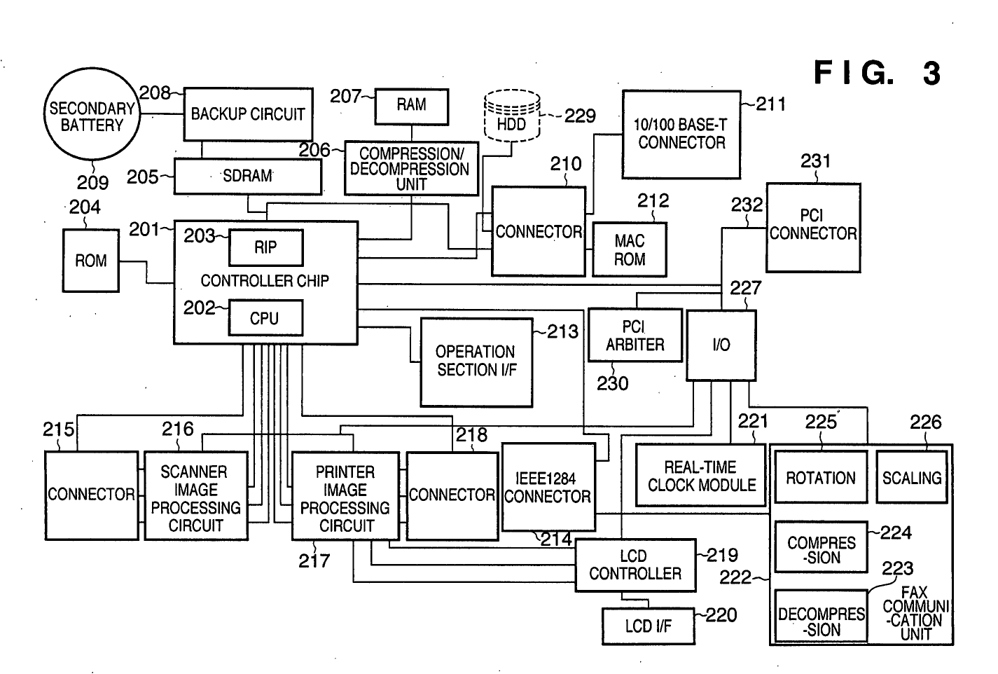

The configuration and operation of signal processing by the control section 104 shown in FIG. 2 will be explained with reference to FIG. 3.

FIG. 3 is a block diagram for explaining the configuration of the control section 104 shown in FIG. 2.

In FIG. 3, reference numeral 201 denotes a controller chip which is a one-chip microcomputer mainly made up of a CPU 202, RIP 203, and the like. The CPU 202 causes functional blocks of the control section 104 to execute processes to be described later. The RIP 203 has a function of expanding a PDL (Page Description Language) format (e.g., PS or PCL) input to the control section 104 from the PC 112 or 118 shown in FIG. 2 or the like in accordance with an instruction from the CPU 202, and converting the PDL format into an image format (bitmap data) which can be output from the printer section 105 connected to the control section 104. The controller chip 201 incorporates a PCI controller (not shown) for controlling a PCI bus (to be described later).

Reference numerals 215 and 218 denote connectors each of which is formed from a bi-directional asynchronous serial I/F and video I/F. The connector 215 is connected to the scanner unit 103 shown in FIG. 2, whereas the connector 218 is connected to the printer unit 106 shown in FIG. 2.

The CPU 202 transmits a control command to the scanner unit 103 via the connector 215, sends an image transfer request, and receives image information from the scanner unit 103. Also, the CPU 202 transmits a control command to the printer unit 106 via the connector 218, sends an image transfer request, and transmits image information to the printer unit 106.

Reference numeral 216 denotes a scanner image processing circuit which performs image processing for an image transferred from the scanner unit 103, and is controlled by the CPU 202 via an I/O 227. The main functions of the scanner image processing circuit 216 are an RGB phase correction function, undercolor removal function, character determination function, image processing function, chromatic color determination/counting function, main scanning scaling function, binarization function, and outline/edge enhancement function.

Note that the above-mentioned RGB phase correction function is to correct a shift of the read phase (sub-scanning position) between color components of the scanner unit 103. The undercolor removal function is to remove the undercolor of an image input from the scanner unit 103. The character determination function is to determine the edge area of a character/thin line part.

Examples of the above-mentioned image processing function are an italic function of converting, into an italic, a portion of an image that is determined by the character determination function to be a character, a mirror image function of reversing an image into a mirror image, and a repeat function capable of outputting a plurality of identical images.

The above-mentioned chromatic color determination/counting function is to divide an image into color and black texts, control a text signal, and determine whether a document image read by the scanner unit 103 is a monochrome or color image. The main scanning scaling function is to scale an image input from the scanner unit 103 in the main scanning direction. The binarization function includes a simple binarization function of binarizing a multilevel signal at a fixed slice level, a binarization function based on a variable slice level which varies from the values of pixels around a pixel of interest, and a binarization function based on error diffusion.

Reference numeral 217 denotes a printer image processing circuit serving as an image processing circuit which performs image processing for an image to be transferred to the printer unit 106, a detailed description of which will be omitted.

An image transferred from the scanner unit 103 is transferred to the printer image processing circuit 217 via the controller chip 201 in accordance with an instruction from the CPU 202. An image having undergone image processing by the printer image processing circuit 217 can be transferred to the connector 218. The printer image processing circuit 217 processes a received image into an optimal one which can be output from the printer unit 106, requests the printer unit 106 to output the image, transfers image information, and can print out a clear image.

Reference numeral 204 denotes a ROM serving as a storage medium which stores the control program of the control section 104 and the like, and mainly stores programs for controlling the overall image forming apparatus.

Reference numeral 205 denotes an SDRAM serving as a volatile storage device which is used as a main memory by the CPU 202. The SDRAM 205 can save various setting values and the like that are required by the control section 104 in operation, and can also directly save image data. Contents saved in the SDRAM 205 can be backed up by a backup circuit 208 and secondary battery 209, and even when the control section 104 is turned off, the stored contents are not lost. Further, the SDRAM 205 saves configuration information of a device connected to the control section 104 (information on a device which builds the image forming apparatus 100 (e.g., information representing whether the finisher unit 107 is attached, information representing the number of printing paper cassettes, and information representing the type of document feeding unit 102)), and the like. When the configuration is changed, the contents of the SDRAM 205 can be updated.

Reference numeral 206 denotes a compression/decompression unit having a function of compressing/decompressing image data by using a RAM 207. Examples of the compression format are JPEG, JBIG, MR, and MMR. The compression/decompression unit 206 is directly connected to the controller chip 201, and can exchange image data with the SDRAM 205. The compression/decompression unit 206 has an image rotation function in addition to a binary image compression/decompression function. This rotation function is to rotate a binarized image clockwise through 90°, 180°, and 270°.

Reference numeral 212 denotes an MACROM serving as a ROM which stores the physical address of a network. The MACROM 212 is connected to the controller chip 201 and SDRAM 205 via a connector 210.

Reference numeral 211 denotes a 10/100 Base-T connector (network connector) which connects the control section 104 to a network (network 120), and exchanges data with the network. Note that the 10/100 Base-T connector 211 is connected to the controller chip 201 via the connector 210.

Reference numeral 213 denotes an operation section I/F which is used to connect the operation section 108 shown in FIG. 2. The operation section 108 comprises a plurality of hard keys (not shown), and the large-size liquid crystal touch panel 108a having a liquid crystal display portion and a touch panel input device adhered onto the liquid crystal display portion. A signal input from the large-size liquid crystal touch panel 108a or hard key is transferred to the CPU 202 via the above-described operation section I/F 213. The liquid display portion has a function of displaying image data sent from the operation section I/F 213, and can also display functions in the operation of the image forming apparatus 100.

Reference numeral 214 denotes an IEEE1284 connector which complies with IEEE1284 and can be connected to the external PC 118. The external PC 118 can issue a scan/print request to the control section 104 via the IEEE1284 connector, and acquire status information of the image forming apparatus 100.

Reference numeral 219 denotes an LCD controller which is used to connect a color LCD (not shown). The LCD controller 219 is controlled by the CPU 202 via the I/O 227, and can display an image on a color LCD which is connected to the LCD controller 219 via an LCD I/F 220.

Reference numeral 221 denotes a real-time clock module which counts time, and has an alarm function of generating an interruption to the CPU 202 at a designated time.

Reference numeral 222 denotes a FAX communication unit which can be connected to a public line. The FAX communication unit 222 has a function of modulating digital data sent from the PC 118 or 112 or the like via the IEEE1284 connector 214 or the like so as to send the data to a public line, and a function of converting modulated data sent from a public line into digital data processible in the image forming apparatus 100. In addition, the FAX communication unit 222 comprises a decompression unit 223, compression unit 224, rotation unit 225, and scaling unit 226 which execute various image processing functions for exchanging an image with another FAX and the like on a public line.

Reference numeral 232 denotes a PCI bus which is controlled by performing arbitration by a PCI arbiter 230 for executing a PCI bus arbitration function. The CPU 202 can transfer data onto the PCI bus 232 via a PCI controller (not shown) incorporated in the controller chip 201. Accordingly, the CPU 202 can access the I/O 227, and communicate with another peripheral device connected to a PCI connector 231.

The HDD 229 is a large-capacity nonvolatile storage device which stores a plurality of applications, image data, and the like for the operation of the CPU 202. Job information containing job data (image data) of most jobs executed in the image forming apparatus 100, various data necessary to execute a job, and the like is temporarily stored in the HDD (storage device) 229. Data is transferred to the printer section 105, or an external apparatus (PC 112 or 118, WS 114, printer 111, FAX 113, or the like) via the network connector 211 or the like.

Note that the image forming apparatus 100 can execute a plurality of jobs including a copy job, print job, first facsimile transmission job, second facsimile transmission job, scanner job, first facsimile reception job, and second facsimile reception job. The copy job is to output, from the printer section 105, an image read by the reader section 101. The print job is to output, from the printer section 105, print data received from the PC 112, WS 114, or the like via the network 120, and print data received from the PC 118. The first facsimile transmission job is to transmit an image read by the reader section 101 to the FAX 117 via the FAX communication unit 222. The second facsimile transmission job is to transmit data received from the PC 112, WS 114, or the like via the network 120 or data received from the PC 118 to the FAX 117 via the FAX communication unit 222. The scanner job is to send an image read by the reader section 101 to the PC 112 or 118, WS 114, or the like. The first facsimile reception job is to output facsimile data received by the FAX communication unit 222 from the printer section 105. The second facsimile reception job is to send facsimile data received by the FAX communication unit 222 to the PC 112 or 118, WS 114, printer 111, or the like.

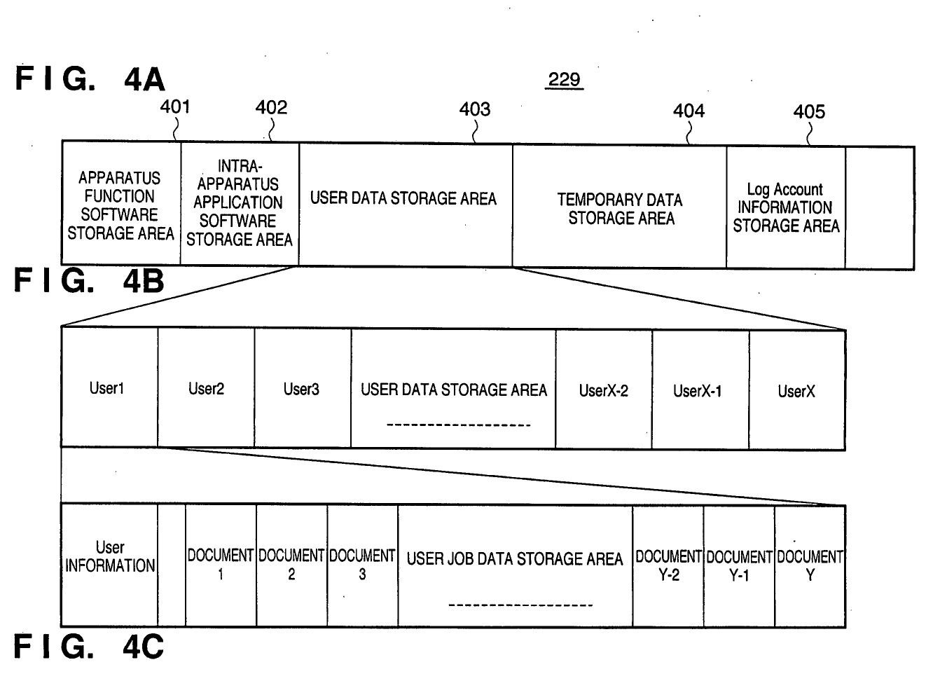

The HDD 229 is used by dividing its interior into a plurality of areas as shown in FIGS. 4A to 4C, which will be described below.

FIGS. 4A to 4C are schematic views for explaining an example of the recording area of the HDD 229 shown in FIG. 3.

In FIG. 4A, reference numeral 401 denotes an apparatus function software storage area which stores a software module for operating the function of the control section 104. Reference numeral 402 denotes an intra-apparatus application software storage area which stores a plurality of applications using functions in the image forming apparatus 100.

Reference numeral 403 denotes a user data storage area which can be utilized by the user, details of which will be described with reference to FIG. 4B. Reference numeral 404 denotes a temporary data storage area which temporarily stores job information of a job whose execution is requested. Reference numeral 405 denotes a Log Account information storage area.

In FIG. 4B, the user data storage area 403 is divided into a plurality of areas. The divided areas (User n (n: 1 to X)) can be utilized as areas for storing user's individual data (user data) and areas for storing group data, like boxes with keys.

As shown in FIG. 4C, information such as the user name, the serial number, the user area password, and the number of user-registered documents is stored as user information in each of the divided areas User 1 to User X of the user data storage area 403. Each of User 1 to User X has a plurality of areas for storing job data, and can save document 1, 2, 3, . . . .

Information such as the document name, job type, and password can be added to each job, and information-added job data is stored as job information.

Processing until a secure communication channel is established between the image forming apparatus 100 serving as an initiator and the HDD 229 serving as a responder will be explained.

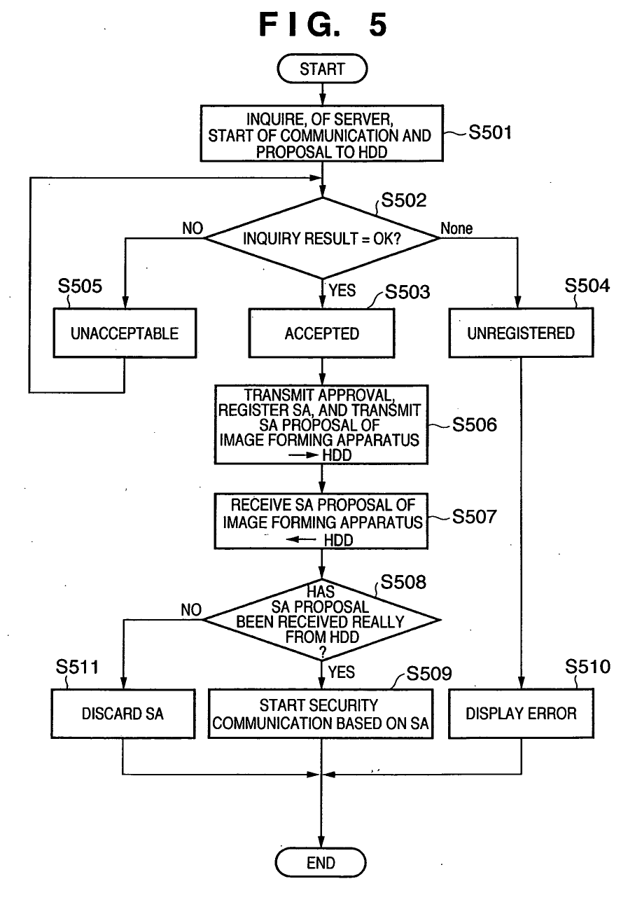

FIG. 5 is a flowchart showing an example of processing when the control section 104 of the image forming apparatus 100 cooperates with the server 130 to issue a request to establish a secure communication channel with the HDD 229.

Assume that the image forming apparatus 100 is assigned in advance with a stored device ID and a secret symmetric key Ka used only for communication with the server 130. The device identifier and secret symmetric key Ka are stored in manufacturing the image forming apparatus 100. Also in the server 130, the device ID and secret symmetric key Ka of the image forming apparatus 100 are registered. The secret symmetric key Ka is anonymously held. The secret symmetric key Ka can be made anonymous by various methods such as data-split, encryption, and a tamper-resistant entity, and any method can be adopted.

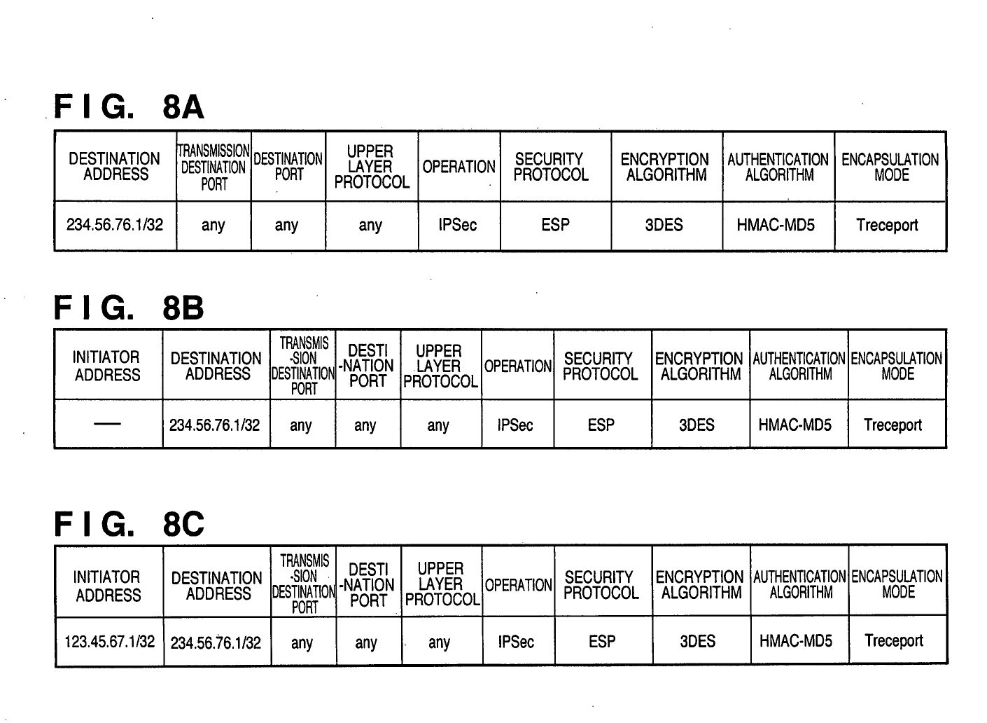

The image forming apparatus 100 comprises a security policy database (SPD) which holds a plurality of security policies set by the user. The security policy includes the use port, security protocol, encryption algorithm, authentication algorithm, and encapsulation mode. FIG. 8A shows an example of the security policy. How to process (e.g., whether to encrypt) a packet input/output to/from the network 120 is determined on the basis of a security policy held in the SPD, and a packet is processed.

The image forming apparatus 100 has a security association database (SAD) which holds a negotiated SA. The SAD is used to determine which of SAs is to be used in secure communication with a predetermined device.

In step 501, the control section 104 of the image forming apparatus 100 inquires, of the server 130, the start of communication and a proposal to the HDD 229. More specifically, the control section 104 transmits a secure communication channel establishment start request inquiry to the server 130 together with a device ID. As the proposal, the control section 104 reads out, from the SPD, information containing the security protocol, encryption algorithm, authentication algorithm, and encapsulation mode by using the IP address of the HDD 229 as a key, and transmits the readout information. The transmission data is encrypted with the secret symmetric key Ka.

The control section 104 receives a response from the server 130. Since the received data is encrypted, it is decrypted with the secret symmetric key Ka to obtain an inquiry result. Similarly in subsequent processing, communication between the control section 104 of the image forming apparatus 100 and the server 130 uses the secret symmetric key Ka, and encryption and decryption are performed in transmission and reception, respectively.

In step 502, the control section 104 determines whether the inquiry result from the server 130 represents “unacceptable”, “accepted”, or “unregistered”.

If the received result represents “accepted”, the flow advances to step 503, and the control section 104 receives the IP address of the HDD 229, an SPD matching result, a secret symmetric key Kc, and an HDD authentication value Aj. Then, the flow advances to step 506.

If the received result represents “unacceptable”, the flow advances to step 505, and returns to step 501 to transmit a new proposal again. If the received result represents “unregistered”, the flow advances to step 504 to send back an error in step 510, and then ends.

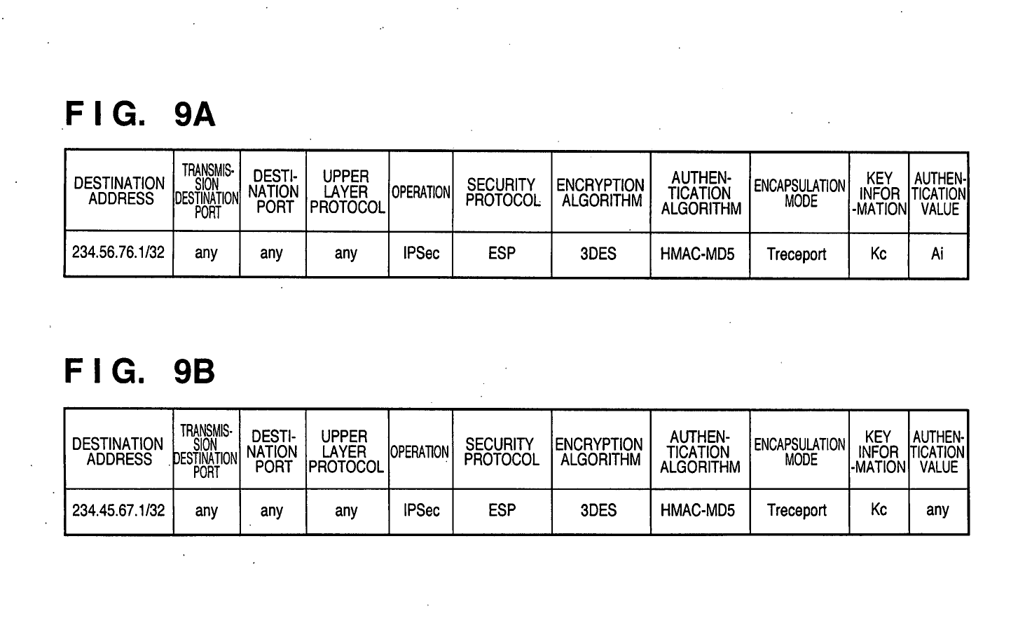

In step 506, the control section 104 transmits an approval message, and registers an SA in the SAD. That is, the control section 104 newly generates an SA addressed to the HDD 229 from the IP address of the HDD 229, the SPD matching result, the secret key Kc, and the authentication value Aj of the HDD 229 that are received from the server 130. The control section 104 registers and holds the SA in the SAD. The SPD matching result is information containing the security protocol, encryption algorithm, authentication algorithm, and encapsulation mode. FIG. 9A shows an example of the SAD.

In step 506, the control section 104 sets the IP address of the HDD 229 as a destination address. An SA proposal addressed to the HDD 229 is directly transmitted from the control section 104 of the image forming apparatus 100 to the HDD 229 in accordance with the received SPD matching value. The SA proposal contains an image forming apparatus authentication value Ai for specifying the image forming apparatus 100. The authentication value Ai is a digest value obtained from the secret key Ka on the basis of the hash function. The hash function used complies with a scheme defined by the SA proposal. Information transmitted to the HDD 229 is encrypted with the secret key Kc on the basis of the SA addressed to the HDD 229. Subsequently, communication between the control section 104 of the image forming apparatus 100 and the HDD 229 uses the secret symmetric key Kc, and encryption and decryption are performed in transmission and reception, respectively.

In step 507, the control section 104 receives an SA proposal addressed to the image forming apparatus 100 from the HDD 229. In step 508, the control section 104 determines whether the SA proposal has been transmitted really from the HDD 229.

More specifically, in step 508, the control section 104 collates the HDD authentication value Aj contained in the SA proposal from the HDD 229 with the value received from the server 130 in step 506, and checks whether these values coincide with each other. If these values coincide with each other, the flow advances to step 509. The control section 104 determines that the SA proposal has been transmitted really from the HDD 229, and starts subsequent secure communication with the HDD 229 on the basis of the registered SA. If these values do not coincide with each other, the flow advances to step 511, and the control section 104 discards the SA registered in step 505.

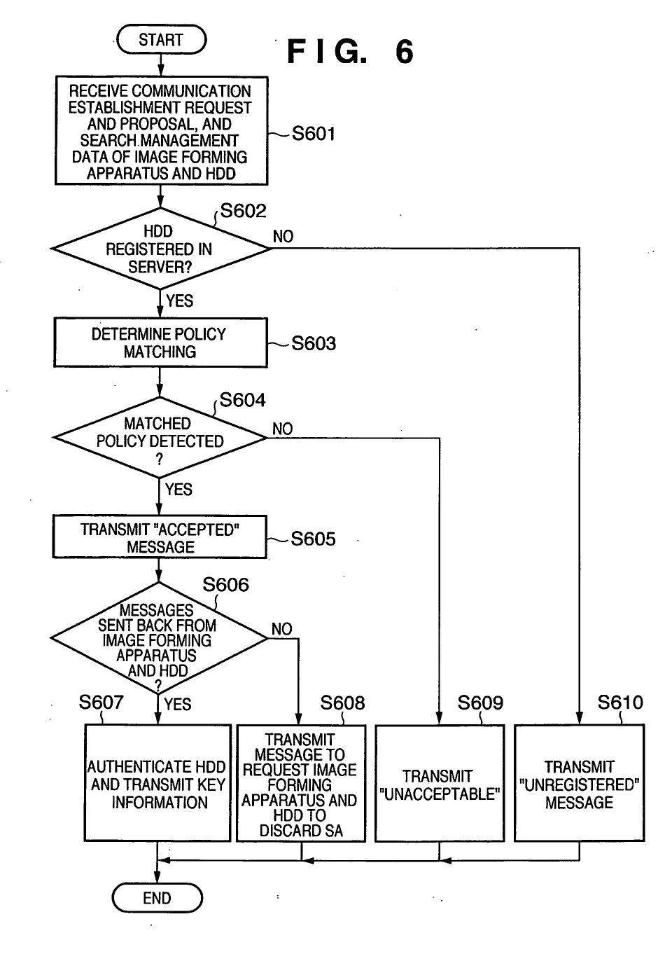

FIG. 6 is a flowchart showing an example of processing when the server 130 performs proxy SA establishment upon reception of a communication channel establishment request from the image forming apparatus 100.

Assume that the device IDs of the image forming apparatus 100 and HDD 229 and paired secret keys Ka and Kb are registered in advance as device attribute information in the server 130. These pieces of information are registered in the server 130 in manufacturing the image forming apparatus 100. Further, the security policies of the image forming apparatus 100 and HDD 229 are registered by their registrants in device-specific SPDs established in the server 130. FIG. 8B shows an example of the security policy. A plurality of security policies can also be registered for respective devices in the SPD of the server 130. The IP addresses of the image forming apparatus 100 and HDD 229 are registered as the IP addresses of responders.

In step 601, the server 130 receives a communication establishment request and proposal, and searches management data of the image forming apparatus 100 and HDD 229. That is, the server 130 receives, from the image forming apparatus 100, a secure communication channel establishment start request inquiry addressed to the HDD 229, the device ID of the image forming apparatus 100, and a communication proposal. Since it is determined from the source address that the received data is encrypted with the secret symmetric key Ka of the image forming apparatus 100, the server 130 decrypts the received data with the secret symmetric key Ka. When the communication destination address represents the image forming apparatus 100, the server 130 encrypts communication data with the secret symmetric key Ka and then transmits the encrypted data. Similarly in subsequent processing, communication between the image forming apparatus 100 and the server 130 uses the secret symmetric key Ka, and encryption and decryption are performed in transmission and reception, respectively.

In step 601, the server 130 uses, as a key, the IP address of the HDD 229 that is contained in the communication channel establishment start request, and determines whether the HDD 229 is registered in the device-specific SPD. The server 130 determines the search result in step 602, and if the HDD 229 is registered, the flow advances to step 603. If the HDD 229 is not registered, the server 130 sends back an “unregistered” message to the image forming apparatus 100 in step 610, and the processing ends.

In step 603, the server 130 compares the security policy of the HDD 229 registered in the SPD with information such as the security protocol, encryption algorithm, authentication algorithm, and encapsulation mode that is contained in the communication proposal. In step 604, the server 130 determines the comparison result.

If no matched policy is detected in step 604, the server 130 transmits “unacceptable” to the image forming apparatus 100 in step 609, and the processing ends.

If a matched policy is detected in step 604, the server 130 transmits an “accepted” message to the image forming apparatus 100 and HDD 229 in step 605. Communication to the HDD 229 is determined from the destination address, and communication data is encrypted with the secret key Kb and transmitted. Reception from the HDD 229 is determined from the source address, and received data is decrypted with the secret symmetric key Kb. Similarly in subsequent processing, communication between the HDD 229 and the server 130 uses the secret symmetric key Kb, and encryption and decryption are performed in transmission and reception, respectively.

The server 130 transmits, to the image forming apparatus 100 together with an “accepted” message, the IP address of the HDD 229, information containing the security protocol, encryption algorithm, authentication algorithm, and encapsulation mode as an SPD matching result, the secret symmetric key Kc used between the image forming apparatus 100 and the HDD 229, and the authentication value Aj of the HDD 229. The authentication value Aj of the HDD 229 is a digest value obtained from the secret symmetric key Kb on the basis of the hash function. The hash function used complies with a scheme defined by an authentication algorithm to be transmitted.

The server 130 transmits, to the HDD 229 together with an “accepted” message, the IP address of the image forming apparatus 100, and information containing the security protocol, encryption algorithm, authentication algorithm, and encapsulation mode as an SPD matching result.

In step 606, the server 130 determines whether it has received approval messages from the image forming apparatus 100 and HDD 229. If the server 130 has received approval messages from the image forming apparatus 100 and HDD 229, it transmits the secret key Kc and the authentication value Ai of the image forming apparatus 100 to the HDD 229 in step 607. The secret key Kc and authentication value Ai are generated similarly to step 605. If the server 130 does not receive any approval message from either or both of the image forming apparatus 100 and HDD 229, it transmits, to the image forming apparatus 100 and HDD 229 in step 608, a message to request them to discard the SA entry of the SAD.

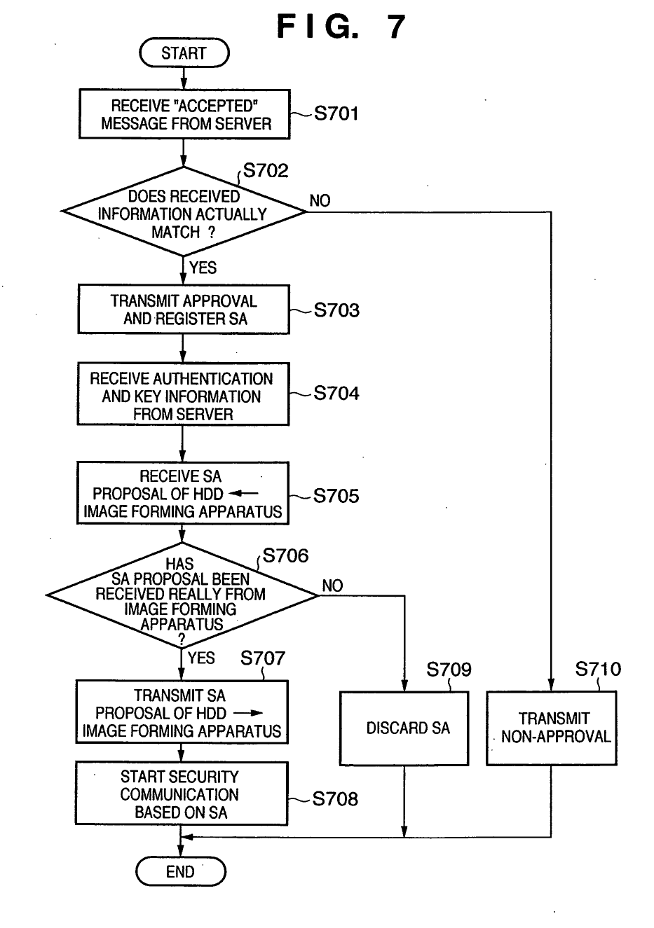

FIG. 7 is a flowchart showing an example of processing when the HDD 229 accepts an SA proposal from the image forming apparatus 100 in cooperation with the server 130. All processes in this flowchart are executed by the HDD 229.

Assume that a device ID and the secret symmetric key Kb used only for communication between the HDD 229 and the server 130 are stored in advance in the HDD 229. These pieces of information are stored in manufacturing the image forming apparatus 100. The device ID of the HDD 229 can also be registered in manufacturing the image forming apparatus 100. Also in the server 130, the device ID and secret symmetric key Kb of the HDD 229 are registered. The secret symmetric key Kb is anonymously held. The secret symmetric key Kb can be made anonymous by various methods such as data-split, encryption, and a tamper-resistant entity, and any method can be adopted.

The HDD 229 comprises a security policy database (SPD) which is set by the user and holds the use port, security protocol, encryption algorithm, authentication algorithm, and encapsulation mode. FIG. 8C shows an example of the SPD. The SPD can hold a plurality of security policies. How to process (e.g., whether to encrypt) a packet input/output to/from the network 120 is determined on the basis of a security policy held in the SPD, and a packet is processed. As described above, a security policy in the SPD is registered even in the server 130 by the user.

The HDD 229 has an SAD which holds an SA. The SAD is used to determine which of SAs is to be used in secure communication with a predetermined device. FIG. 9B shows an example of the SAD.

In step 701, the HDD 229 receives, together with an “accepted” message from the server 130, the IP address of the image forming apparatus 100, and information containing the security protocol, encryption algorithm, authentication algorithm, and encapsulation mode. Reception from the server 130 is determined from the source address, and communication data is decrypted with the secret symmetric key Kb and received. Transmission to the server 130 is determined from the source address, and transmission data is encrypted with the secret symmetric key Kb. Similarly in subsequent processing, communication between the HDD 229 and the server 130 uses the secret symmetric key Kb, and encryption and decryption are performed in transmission and reception, respectively.

In step 702, the HDD 229 confirms whether the received information containing the security protocol, encryption algorithm, authentication algorithm, and encapsulation mode actually matches a security policy held in the SPD of the HDD 229.

If the information matches the security policy, the HDD 229 transmits an approval message to the server 130 in step 703. The HDD 229 newly generates an SA addressed to the image forming apparatus 100 from the received IP address of the image forming apparatus 100, and the received information containing the security protocol, encryption algorithm, authentication algorithm, and encapsulation mode. The HDD 229 holds the generated SA in the SAD.

In step 704, the HDD 229 receives the secret symmetric key Kc for access from the image forming apparatus 100 and the authentication value Ai of the image forming apparatus 100 from the server 130, and adds these pieces of information to the SA entry generated in step 703.

In step 705, the HDD 229 receives an SA proposal addressed to the HDD 229 from the image forming apparatus 100. Since data received from the image forming apparatus 100 is encrypted with the secret symmetric key Kc on the basis of the registered SA, the HDD 229 decrypts the data with the secret symmetric key Kc received from the server 130. Similarly in subsequent processing, communication between the image forming apparatus 100 and the HDD 229 uses the secret symmetric key Kc, and encryption and decryption are performed in transmission and reception, respectively.

In step 706, the HDD 229 collates the image forming apparatus authentication value Ai contained in the SA proposal from the image forming apparatus 100 with the value received from the server 130 in step 704, and checks whether these values coincide with each other.

If these values coincide with each other, the HDD 229 determines that the SA proposal has been transmitted really from the image forming apparatus 100. In step 707, the HDD 229 transmits an SA proposal addressed to the image forming apparatus 100. The SA proposal contains the HDD authentication value Aj for specifying the HDD 229. The authentication value Aj is a digest value obtained from the secret symmetric key Kb on the basis of the hash function. The hash function used complies with a scheme defined by the SA proposal. If these values do not coincide with each other, the HDD 229 discards the registered SA in step 709. In step 708, subsequent secure communication between the image forming apparatus 100 and the HDD 229 starts on the basis of the registered SA.

In this manner, the image forming apparatus 100 according to the embodiment comprises the reader section 101 which inputs a document image as digital image data, and the control section 104 which can exchange a processing request and information from an external apparatus such as a PC and can transfer image data and the like to an external PC, the printer 111, or the printer section 105 in accordance with an external request. Further, the image forming apparatus 100 comprises the RAM 207 and SDRAM 205 serving as volatile memories, the ROM 204 serving as a nonvolatile memory, and the HDD 229 serving as a large-capacity permanent storage unit. Communication can be done only after communication negotiations between the control section 104 and the HDD 229 are authenticated by the authentication server.

According to the embodiment, when data from the image forming apparatus 100 is to be received in the HDD 229, encrypted data is decrypted with the secret key Kc, and the decrypted data is stored. When the decrypted data is transmitted again from the HDD 229 to the image forming apparatus 100, the data is encrypted with the secret key Kc, and the encrypted data is transmitted. Alternatively, encrypted data received from the image forming apparatus 100 may be directly stored in the HDD 229, and directly transmitted from the HDD 229 to the image forming apparatus 100.

The above embodiment has described simply an image forming apparatus. The image forming apparatus includes an electrophotographic apparatus, a digital copying machine, a monochrome copying machine, a color laser copying machine, a laser beam printer, a color laser printer, an inkjet printer, a thermal transfer printer, a facsimile apparatus, and a multi-functional copying machine having the copying function and/or printing function and/or the facsimile function. Further, a control apparatus, information processing apparatus, data processing apparatus, and the like which control various image forming apparatuses also fall within the scope of the present invention.

In the above embodiment, the HDD 229 is incorporated in the image forming apparatus 100. However, the HDD 229 need not be especially arranged in the image forming apparatus 100, and the installation location of the HDD 229 is arbitrary as far as the HDD 229 is connected in an environment where it communicates through the network 120.

As described above, the embodiment has explained an image forming system comprising an image forming apparatus and storage device which are connected to each other via a network and store unique information in advance, and a server which manages the information unique to the image forming apparatus and storage device and a security policy database. In the image forming system, in response to a request from the image forming apparatus, the server executes security information negotiations between the image forming apparatus and the storage device, generation and distribution of keys for use, and generation and distribution of authentication keys. In this way, the server performs proxy establishment of a security association between the image forming apparatus and the storage device.

Hence, communication between the image forming apparatus and the storage device can be efficiently, securely performed.

The pieces of unique information are stored in the image forming apparatus and storage device upon data-split, encryption, tamper-resistant processing, and the like so that the pieces of unique information cannot be read out by a general method.

Conventionally, data in the image forming apparatus is protected by a user authentication means including a password. When one wants to steal information in the image forming apparatus, it is assumed he or she steals the whole image forming apparatus or a storage device (e.g., HDD) which stores information, in order to analyze data. However, even if the entire image forming apparatus is stolen and is to be operated in an environment having a different global address, no proxy authentication using the security policy database is established. Thus, data communication with the storage device fails, and no data is used. When encrypted data is stored in the storage device such as an HDD, information does not leak even if the image forming apparatus or HDD is stolen.

### Other Embodiment

The embodiment of the present invention has been described in detail. The present invention may be applied to a system including a plurality of devices or an apparatus formed by a single device.

The present invention is also achieved by supplying a program for implementing the functions of the above-described embodiment to a system or apparatus directly or from a remote place, and reading out and executing the supplied program codes by the computer of the system or apparatus. The program codes themselves installed in the computer in order to implement functional processes of the present invention by the computer also fall within the technical scope of the present invention.

In this case, the form of the program is arbitrary such as an object code, a program executed by an interpreter, or script data supplied to an OS as far as a program function is attained.

A recording medium for supplying the program includes a floppy® disk, hard disk, optical disk, magnetooptical disk, MO, CD-ROM, CD-R, CD-RW, magnetic tape, nonvolatile memory card, ROM, and DVD (DVD-ROM and DVD-R).

As another program supply method, the program can be supplied by connecting a client computer to an Internet Web page via the browser of the client computer, and downloading the computer program of the present invention or a compressed file containing an automatic installing function from the Web page to a recording medium such as a hard disk. The program can also be implemented by grouping program codes which form the program of the present invention into a plurality of files, and downloading the files from different Web pages. That is, the present invention also includes a WWW server which allows a plurality of users to download the program files for implementing functional processing of the present invention by a computer.

The program of the present invention can be encrypted, stored in a recording medium such as a CD-ROM, and distributed to the user. A user who satisfies predetermined conditions is prompted to download decryption key information from a Web page via the Internet. The user executes the encrypted program by using the key information, and installs the program in the computer.

The functions of the above-described embodiment are implemented when the computer executes the readout program. Also, the functions of the above-described embodiment are implemented when an OS or the like running on the computer performs part or all of actual processing on the basis of the instructions of the program.

The functions of the above-described embodiment are implemented when the program read out from the recording medium is written in the memory of a function expansion board inserted into the computer or the memory of a function expansion unit connected to the computer, and the CPU of the function expansion board or function expansion unit performs part or all of actual processing on the basis of the instructions of the program.

According to the above embodiment, leakage of data in a storage device can be easily prevented, and communication between the image forming apparatus and the storage device can be efficiently, securely performed.

As many apparently widely different embodiments of the present invention can be made without departing from the spirit and scope thereof, it is to be understood that the invention is not limited to the specific embodiments thereof except as defined in the appended claims.

The application claims the benefit of Japanese Application No. 2005-136504, filed May 9, 2005, which is hereby incorporated by reference herein in its entirety.

What is claimed is:

1. An image forming system comprising an image forming apparatus which is connected to a storage device and forms an image by using information read out from the storage device, and an information processing apparatus which manages the image forming apparatus, wherein
the information processing apparatus determines whether to permit communication between the storage device and the image forming apparatus.

2. The system according to claim 1, wherein
each of the image forming apparatus and the storage device has unique information,
the information processing apparatus comprises a memory which stores the unique information of the image forming apparatus and the unique information of the storage device, and
upon reception of a request to access the storage device from the image forming apparatus, the information processing apparatus determines whether unique information contained in the access request is stored in the memory, and thereby determines whether to permit communication between the storage device and the image forming apparatus.

3. The system according to claim 1, wherein
the memory of the information processing apparatus further stores a security policy database, and
upon reception of a request to access the storage device from the image forming apparatus, the information processing apparatus confirms consistency of a security policy between the image forming apparatus and the storage device.

4. The system according to claim 1, wherein when the information processing apparatus permits communication between the image forming apparatus and the storage device, the information processing apparatus distributes a common secret symmetric key to the image forming apparatus and the storage device, and performs communication between the image forming apparatus and the storage device by using the secret symmetric key.

5. The system according to claim 2, wherein the pieces of unique information are stored in the image forming apparatus and the storage device by one of data-split, encryption, and tamper-resistant processing.

6. The system according to claim 1, wherein the image forming apparatus transmits encrypted information to the storage device and stores the encrypted information in the storage device, and the storage device reads out encrypted information and transmits the encrypted information to the image forming apparatus.

7. An image forming apparatus which is connected to a storage device and forms an image by using information read out from the storage device, wherein
the image forming apparatus inquires, of an information processing apparatus which manages the image forming apparatus, whether to permit communication between the image forming apparatus and the storage device.

8. A storage device which stores information to be supplied to an image forming apparatus for forming an image, wherein
the storage device establishes communication with the image forming apparatus after waiting for permission from an information processing apparatus which manages the image forming apparatus.

9. A communication control method of causing an information processing apparatus to control communication between a storage device and an image forming apparatus which forms an image while saving information in the storage device, comprising:
causing the information processing apparatus to determine whether to permit communication between the storage device and the image forming apparatus.

10. The method according to claim 9, further comprising steps of:
causing the image forming apparatus to request the information processing apparatus to establish communication with the storage device; and
causing the information processing apparatus to determine whether the requesting image forming apparatus and the storage device are management targets.

11. A communication control program of controlling communication between a storage device and an image forming apparatus which forms an image while saving information in the storage device, comprising
determining whether to permit communication between the storage device and the image forming apparatus.
